(19) United States
(12) Patent Application Publication
(10) Pub. No.: US 2010/0165810 A1
(43) Pub. Date: Jul. 1, 2010

(54) NOISE REMOVING APPARATUS AND METHOD, AND OPTICAL PICKUP

(75) Inventor: Yoshinari Kuwabara, Tokorozawa-shi (JP)

Correspondence Address: YOUNG & THOMPSON, 209 Madison Street, Suite 500, Alexandria, VA, 22314, US

(73) Assignee: PIONEER CORPORATION, TOKYO (JP)

(21) Appl. No.: 12/376,498

(22) PCT Filed: Aug. 24, 2006
(86) PCT No.: PCT/JP2006/316599

§ 371 Date: Feb. 5, 2009

(51) Int. Cl. G11B 20/00; G11B 7/135

(52) U.S. Cl. 369/47.17; 369/112.01; G9B/20; G9B/7.113

(57) ABSTRACT

An optical pickup includes: light collecting element for selectively collecting main and sub beams emitted toward an optical disc formed by layering at least first and second recording layers, onto one of first and second recording layers; main and sub light reception elements receiving the main and sub light from the main and sub beams collected from the optical disc and outputting main and sub light signals; tracking error signal generator for generating a tracking error signal according to the sub light signal; noise component calculator for calculating a noise component generated by interference between the sub light and an invalid light attributed to at least one of the applied main and sub beams and received together with the sub light and the sub light from the other of the first and the second recording layer; and noise remover for removing the calculated noise component from the tracking error signal.

### TECHNICAL FIELD

The present invention relates to an optical disc apparatus for recording or reproducing information while generating a tracking error signal by irradiating an optical disc with a beam, wherein the optical disc is provided with at least first and second recording layers laminated, such as a DVD. The present invention particularly relates to a new noise removing apparatus and method for removing noise in a tracking error signal, and an optical pickup for generating a low-noise tracking error signal.

### BACKGROUND ART

If information is recorded or reproduced on an optical disc by this type of optical disc apparatus, for example, a differential push-pull method (DPP) by three beams is used for the generation of a tracking error signal (refer to a patent document 1). In the DPP method, the reflected light of a main beam and those of sub beams from the optical disc are detected by respective light receiving elements to generate three push-pull signals. Then, the differential between the push-pull signal of the main beam and the push-pull signals of the sub beams allows the generation of the tracking error signal.

In the optical disc, such as a DVD, on which tracking is performed on the basis of the tracking error signal, in order to increase its recording capacity, an optical disc with a structure that two recording layers are laminated on one side (hereinafter referred to as a “dual-layer disc”) is used in some cases. If the information is recorded or reproduced on the dual-layer disc, the tracking is performed with the focus position of a light spot placed on the target layer.

Patent document 1: Japanese Patent Application Laid Open NO. Hei 11-273118

### DISCLOSURE OF INVENTION

### Subject to be Solved by the Invention

However, if the tracking is performed on the dual-layer disc, there are not only the focused reflected light from the one target layer on the light receiving element but also the defocused reflected light of mainly the main beam from the other non-target layer, on the light receiving elements. Thus, the reflected lights from the one layer and the reflected lights from the other layer interfere and form an interference pattern on the light receiving elements. The interference pattern constantly changes and becomes the noise of the push-pull signals as long as the optical disc is activated, i.e. as long as the information is recorded or reproduced on the optical disc.

Incidentally, not only the dual-layer disc but also a multilayer disc with three or more recording layers laminated have the same technical problems.

In view of the aforementioned problems, it is therefore an object of the present invention to provide a noise removing apparatus and method capable of reducing the noise in the tracking error signal in recording or reproducing information by irradiating, with a beam, an optical disc formed with a plurality of recording layers laminated and an optical pickup capable of providing a low-noise tracking error signal by the noise removing method.

### Means for Solving the Subject

The above object of the present invention can be achieved by a noise removing apparatus in an optical pickup provided with: an irradiating device for irradiating a main beam and sub beams toward an optical disc in which at least first and second recording layers are laminated; a focusing device for selectively focusing the emitted main beam and sub beams, on one of the first and second recording layers; a main light receiving element for receiving main light from the optical disc caused by the focused main beam and outputting a main light signal; sub light receiving elements for receiving sub lights from the optical disc caused by the focused sub beams and outputting sub light signals; and a tracking error signal generating device for generating a tracking error signal on the basis of the sub light signals, the noise removing apparatus provided with: a noise component arithmetic device for calculating, on the basis of the main light signal and the sub light signals, a noise component generated in the sub light signals due to an interference between the sub lights and invalid lights, the invalid lights being caused by at least one of the main beam and the sub beams, the invalid lights come from the other of the first and second recording layers, and the invalid lights are received with the sub lights by the sub light receiving elements; and a noise removing device for removing the calculated noise component from the tracking error signal.

According to the noise removing apparatus of the present invention, the beam emitted from the irradiating device such as a semiconductor laser is divided into the main beam and the sub beams, for example, by diffraction grating, and the divided beams are focused on the optical disc such as a DVD by the focusing device such as an objective lens. The optical disc is formed in which at least the first and second recording layers are laminated. Thus, when information is recorded or reproduced on the optical disc, the main beam and the sub beams are selectively focused to place a focal point on desired one of the first and second recording layers by the focusing device.

Lights from the optical disc caused by the focused light beams, which are typically reflected lights, are focused on the main light receiving element and the sub light receiving elements corresponding to the main beam and the sub beams, respectively. The “light receiving element” of the present invention is, for example, an electronic part for converting light to an electrical signal, such as an optical integrated circuit, referred to as a photodetector. The light receiving surface of the light receiving element is divided into two sections by at least a parting line extending in a direction optically corresponding to a direction of crossing the track of the optical disc (i.e. the radial direction of the disc). Alternatively, the light receiving surface of the light receiving element is also divided into four sections by a parting line extending in a direction optically corresponding to a direction along the track. The light receiving element outputs, in each section, a light receiving signal according to the amount of light in each section. Moreover, the “lights from the optical disc caused by the focused light beams” in the present invention are typically the reflected lights; however, another type of light may be used, such as transmitted light, diffraction light, and refracting light.

The tracking error signal generating circuit, in which, for example, a plurality of arithmetic circuits are combined, generates the tracking error signal on the basis of the sub light signals.

In particular, in the case of the optical disc formed with at least the first and second recording layers laminated, the reflected lights from one recording layer which is a recording or reproduction target and the reflected lights, i.e. the invalid lights, from the other recording layer which is not the recording or reproduction target interfere and form an interference pattern on the light receiving elements. The “invalid lights” of the present invention denote lights which come from the recording layer that is not the recording or reproduction target and which are unhelpful to the recording or reproduction or which hinder the recording or reproduction, in a multilayer disc. In particular, the beam intensity of the sub lights is weak, for example, 7% of that of the main light, and it is similar to that of the reflected lights from the other layer, and thus it is significantly influenced by the reflected lights from the other layer (i.e. the invalid lights). As a result, if no countermeasures are taken, the sub light signals caused by the sub lights with the low beam intensity come with the noise component caused by the aforementioned interference, to a non-negligible degree. Thus, for example, if the tracking error signal is generated by the DPP method, the outputted tracking error signal shows the influence of the noise.

According to the study of the present inventors, however, the ideal main light signal without the noise component and the ideal sub light signals without the noise component are in antiphase and have the same shape. Therefore, it is found that the noise component, i.e. the distortion of the signal by the aforementioned interference, can be calculated on the basis of the main light signal which does not have the adverse influence of the reflected lights from the recording layer which is not the recording or reproduction target in the intensity relationship (i.e. the adverse influence by the interference with the invalid lights) and on the basis of the sub light signals which has the adverse influence and thus come with the noise component.

Thus in the present invention, the noise component arithmetic device, which is for example an arithmetic circuit, calculates the noise component generated in the sub light signals on the basis of the main light signal and the sub light signals, and the noise removing device, which is for example an arithmetic circuit, removes the calculated noise component from the tracking error signal.

Incidentally, the noise removing device may remove the noise component at a stage of the sub light signals in each of the sub light signals, at a stage of a sum signal generated during the generation of the tracking error signal, or at a stage of the tracking error signal. In other words, the tracking signal may be generated while the noise component is removed.

Consequently, it is possible to reduce the noise in the tracking error signal in recording or reproducing information by irradiating the optical disc formed with the plurality of recording layers laminated, with the beam.

In one aspect of the noise removing apparatus of the present invention, the noise component arithmetic device adds a first arithmetic signal, which is obtained by multiplying the sub light signals by a constant, and the main light signal, and removes a direct current component of the added signal, to thereby calculate the noise component.

According to this aspect, the main light signal and the first arithmetic signal, which is obtained by multiplying the sub light signals by the constant, are added and the direct current component is removed, by the noise component arithmetic device, which has for example an addition circuit and a capacitor, thereby calculating the noise component, relatively easily.

In an aspect in which the first arithmetic signal is used, the noise removing device may remove the noise component from the tracking error signal by removing the noise component from the first arithmetic signal.

By virtue of such construction, the noise component is removed from the first arithmetic signal by the noise removing device, which is, for example, a subtraction circuit. By this, the noise component is removed from the first arithmetic signal accompanied by the noise component, which is, for example, the push-pull signal of the sub beams. Thus, it is possible to reduce the noise in the tracking error signal.

Alternatively, in an aspect in which the first arithmetic signal is used, the noise removing device may remove the noise component from the tracking error signal by removing the noise component from a second arithmetic signal, which is obtained by subtracting the first arithmetic signal from the main light signal.

By virtue of such construction, the noise component is added to the second arithmetic signal, which is obtained by subtracting the first arithmetic signal from the main light signal, by the noise removing device, which is, for example, an addition circuit. By this, the noise component is removed from the second arithmetic signal accompanied by the noise component, which is, for example, a DPP signal. Thus, it is possible to reduce the noise in the tracking error signal.

The above object of the present invention can be also achieved by a noise removing method, in an optical pickup provided with: an irradiating device for irradiating a main beam and sub beams toward an optical disc in which at least first and second recording layers are laminated; a focusing device for selectively focusing the emitted main beam and sub beams, on one of the first and second recording layers; a main light receiving element for receiving main light from the optical disc caused by the focused main beam and outputting a main light signal; sub light receiving elements for receiving sub lights from the optical disc caused by the focused sub beams and outputting sub light signals; and a tracking error signal generating device for generating a tracking error signal on the basis of the sub light signals, the noise removing method removing a noise component generated in the sub light signals due to an interference between the sub lights and, invalid lights, the invalid lights being caused by at least one of the main beam and the sub beams, the invalid lights come from the other of the first and second recording layers, and the invalid lights are received with the sub lights by the sub light receiving elements, the noise removing method provided with: a noise component arithmetic process of calculating the noise component, on the basis of the main light signal and the sub light signals; and a noise removing process of removing the calculated noise component from the tracking error signal.

According to the noise removing method of the present invention, as in the noise removing apparatus of the present invention, it is possible to reduce the noise in the tracking error signal in recording or reproducing information by irradiating the optical disc formed with the plurality of recording layers laminated, with the beam.

Incidentally, even the noise removing method of the present invention can adopt the same various aspects as those of the noise removing apparatus of the present invention.

The above object of the present invention can be also achieved by an optical pickup provided with: an irradiating device for irradiating a main beam and sub beams toward an optical disc in which at least first and second recording layers are laminated; a focusing device for selectively focusing the emitted main beam and sub beams, on one of the first and second recording layers; a main light receiving element for receiving main light from the optical disc caused by the focused main beam and outputting a main light signal; sub light receiving elements for receiving sub lights from the optical disc caused by the focused sub beams and outputting sub light signals; a tracking error signal generating device for generating a tracking error signal on the basis of the sub light signals; a noise component arithmetic device for calculating, on the basis of the main light signal and the sub light signals, a noise component generated in the sub light signals due to an interference between the sub lights and invalid lights, the invalid lights being caused by at least one of the main beam and the sub beams, the invalid lights come from the other of the first and second recording layers, and the invalid lights are received with the sub lights by the sub light receiving elements; and a noise removing device for removing the calculated noise component from the tracking error signal.

According to the optical pickup of the present invention, as in the noise removing apparatus of the present invention, it is possible to obtain the low-noise tracking error signal in recording or reproducing information by irradiating the optical disc formed with the plurality of recording layers laminated, with the beam.

Incidentally, even the optical pickup of the present invention can adopt the same various aspects as those of the noise removing apparatus of the present invention.

The operation and other advantages of the present invention will become more apparent from Best Mode for Carrying Out the Invention explained below.

### BRIEF DESCRIPTION OF DRAWINGS

FIG. 1 is a block diagram showing an optical pickup in a first embodiment.

FIG. 2 is a block diagram showing a light receiving device in the first embodiment.

FIG. 3 are views showing signals or the like outputted from the light receiving device in the first embodiment.

FIG. 4 is a block diagram showing a tracking error signal generating device in the first embodiment.

FIG. 5 are views showing signals accompanied by the signal processing in the tracking error signal generating device in the first embodiment.

FIG. 6 is a block diagram showing a tracking error signal generating device in a second embodiment.

### DESCRIPTION OF REFERENCE CODES

1 optical pickup
11 semiconductor laser
12 diffraction grating
13 half mirror
14 optical disc
15 light receiving device
16 collimator lens
17 objective lens
20 tracking error signal generating device
21 noise component arithmetic device
22 noise removing device

### BEST MODE FOR CARRYING OUT THE INVENTION

Hereinafter, embodiments of the present invention will be explained with reference to the drawings.

### First Embodiment

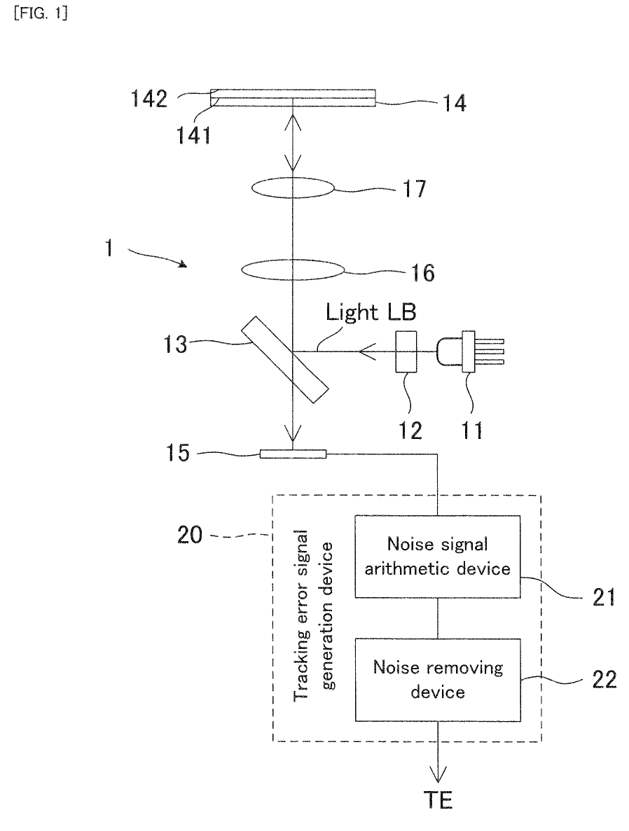

A first embodiment of the noise removing apparatus and method, and the optical pickup of the present invention will be explained with reference to FIG. 1 to FIG. 5.

Firstly, with reference to FIG. 1, the structure of the optical pickup in the embodiment will be explained. FIG. 1 is a block diagram showing the optical pickup in the first embodiment.

In FIG. 1, an optical pickup 1 is provided with a semiconductor laser 11, a diffraction grating 12, a half mirror 13, a light receiving device 15, a collimator lens 16, an objective lens 17, and a tracking error signal generating device 20. The tracking error signal generating device 20 is provided with a noise component arithmetic device 21 and a noise removing device 22.

Incidentally, the “semiconductor laser 11” and the “objective lens 17” in the embodiment are one example of the “irradiating device” and the “light focusing device” of the present invention, respectively. The “tracking error signal generating device 20”, the “noise component arithmetic device 21”, and the “noise removing device 22” in the embodiment are one example of the “tracking error signal generating device”, the “noise component arithmetic device”, and the “noise removing device” of the present invention, respectively.

A beam emitted from the semiconductor laser 11 is divided into a main beam and two sub beams by the diffraction grating 12, is reflected by the half mirror 13, and is focused on the optical disc 14 formed with recording layers 141 and 142 laminated, through the collimator lens 16 and the objective lens 17. The reflected light of the beam from the optical disc 14 is transmitted through the objective lens 17, the collimator lens 16, and the half mirror 13 and is focused on the light receiving device 15. Incidentally, the “main beam” in the embodiment is one example of the “main beam” of the present invention, and the “sub beam” in the embodiment is one example of the “sub beam” of the present invention. The “recording layers 141 and 142” in the embodiment are one example of the “first and recording layers” of the present invention.

The half mirror 13 reflects the beam from the semiconductor laser 11 and transmits therethrough the reflected light of the beam from the optical disc 14. The half mirror 13 may be, for example, a dichroic mirror and a dichroic prism. The light receiving device 15 receives the reflected light of the beam from the optical disc 14 and outputs a light receiving signal according to the amount of the light received.

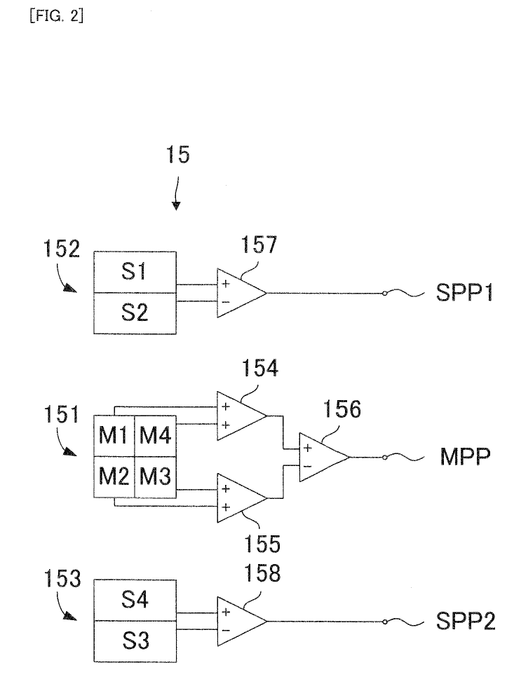

Here, the light receiving device 15 will be explained with reference to FIG. 2. FIG. 2 is a block diagram showing the light receiving device 15 in the first embodiment.

The light receiving device 15 has a light receiving element 151 for receiving the reflected light of the main beam from the optical disc 14 caused by the main beam and outputting a main light signal; and light receiving elements 152 and 153 for receiving the reflected lights of the sub beams from the optical disc 14 caused by the sub beams and outputting sub light signals. The light receiving device 15 further has addition circuits 154 and 155 and subtraction circuits 156 to 158. Incidentally, the “reflected light of the main beam” and the “reflected lights of the sub beams” in the embodiment are one example of the “main light” and the “sub lights” of the present invention, respectively. Moreover, the “light receiving element 151” and the “light receiving elements 152 and 153” in the embodiment are one example of the “main light receiving element” and the “sub light receiving elements” of the present invention, respectively.

The light receiving surface of the light receiving element 151 is divided into four sections by a parting line extending in a direction optically corresponding to a direction of crossing the track of the optical disc 14 (i.e. in the radial direction of the disc) and a parting line extending in a direction optically corresponding to a direction along the track. The light receiving element 151 outputs signals M1 to M4 in respective sections of the light receiving surface. The addition circuit 154 adds the signal M1 and the signal M4. The addition circuit 155 adds the signal M2 and the signal M3. The subtraction circuit 156 subtracts the output from the addition circuit 155 from the output from the addition circuit 154. By this, a signal MPP caused by the main beam is generated, wherein the signal MPP is denoted by (M1+M4)−(M2+M3). The “signal MPP” in the embodiment is one example of the “main light signal” of the present invention.

Each of the light receiving surfaces of the light receiving elements 152 and 153 is divided into two sections by a parting line optically extending in the direction of crossing the track. The light receiving element 152 outputs signals S1 and S2 in the respective sections of the light receiving surface. The subtraction circuit 157 subtracts the signal S2 from the signal S1. By this, a signal SPP1 caused by the first sub beam is generated, wherein the signal SPP1 is denoted by (S1−S2). The light receiving element 153 outputs signals S3 and S4 in the respective sections of the light receiving surface. The subtraction circuit 158 subtracts the signal S3 from the signal S4. By this, a signal SPP2 caused by the second sub beam is generated, wherein the signal SPP2 is denoted by (S4−S3). Incidentally, each of the light receiving surfaces of the light receiving elements 152 and 153 may be further divided into four sections by a parting line extending in the direction optically corresponding to the direction along the track.

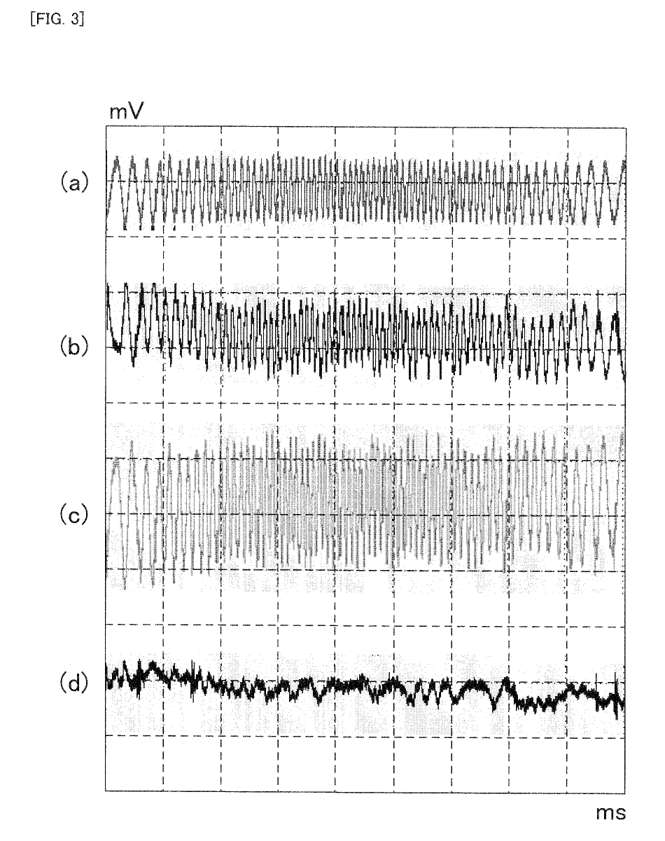

FIG. 3 are views showing signals or the like outputted from the light receiving device 15 in the first embodiment. FIG. 3(a) is one example of the signal MPP. FIG. 3(b) is one example of the signal SPP denoted by (SPP1+SPP2), wherein the signal SPP1 and the signal SPP2 are added by, for example, an addition circuit or the like following the light receiving device 15. The “signal SPP” in the embodiment is one example of the “sub light signals” of the present invention.

As seen from FIG. 3(b), the signal SPP has winding or a swell. This is due to a noise component caused by the reflected lights of the main beam and the sub beams from the optical disc 14. Specifically, for example, if information is recorded or reproduced in the recording layer 141, the reflected lights from the recording layer 141 and the reflected lights from the recording layer 142 interfere with each other. By this, an interference pattern is formed on the light receiving elements 151 to 153 and appears in the outputs form the light receiving elements 151 to 153 as the noise component. However, compared to the reflected lights from the recording layer 141, the reflected lights from the recording layer 142 are defocused. Thus, there is little influence appearing, as shown in FIG. 3(a), in the signal MPP caused by the reflected light of the main beam with high beam intensity from the recording layer 141; however, there is a significant influence, as shown in FIG. 3(b), in the signal SPP caused by the reflected lights of the sub beams with low beam intensity from the recording layer 141.

Therefore, a DPP signal denoted by {MPP−α×(SPP1+SPP2)}, i.e. the tracking error signal by the DPP method, also has a noise component (FIG. 3(c)). Here, α is an arbitrary coefficient.

Thus in the present invention, the noise component arithmetic device 21, described later, calculates the noise component as shown in FIG. 3(c) and removes the calculated noise component from the tracking error signal.

Back in FIG. 1 again, the tracking error signal generating device 20 generates a tracking error signal TE on the basis of the signal SPP. The noise component arithmetic device 21 calculates, on the basis of the signals MPP and SPP, the noise component generated in the signal SPP due to the interference between the reflected lights of the sub beams and invalid lights, wherein the invalid lights are caused by at least one of the main beam and the sub beams, the invalid lights come from the recording layer that is not the target of the information recording or reproduction of the recording layers 141 and 142, and the invalid lights are received with the reflected lights of the sub beams by the light receiving elements 152 and 153. The noise removing device 22 removes the calculated noise component from the tracking error signal TE.

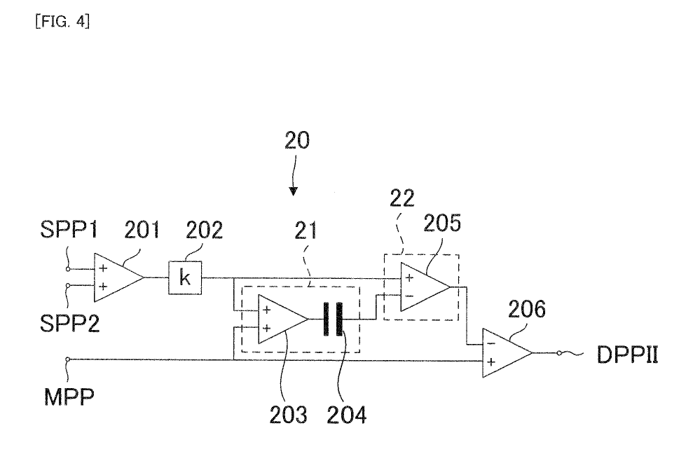

Next, with reference to FIG. 4, an explanation will be given on the method of calculating the noise component generated in the signal SPP and removing the noise component from the tracking error signal TE, in the tracking error generating device 20. FIG. 4 is a block diagram showing the tracking error signal generating device 20 in the first embodiment.

The tracking error signal generating device 20 is provided with addition circuits 201 and 203, subtraction circuits 205 and 206, an amplification circuit 202, and a capacitor 204.

The addition circuit 201 adds the signal SPP1 and the signal SPP2. By this, the signal SPP is generated which is denoted by (SPP1+SPP2)=(S1+S4−S2−S3). The amplification circuit 202 amplifies the signal SPP by a predetermined gain k. By this, a signal kSPP is generated which is denoted by (k×SPP). Here, the predetermined gain k is an arbitrary coefficient expressed by a ratio of the amplitude of the signal MPP and the amplitude of the signal SPP. Incidentally, the “signal kSPP” in the embodiment is one example of the “first arithmetic signal” of the present invention.

The addition circuit 203 adds the signal kSPP and the signal MPP. The capacitor 204 removes a direct current component from the signal added by the addition circuit 203. By this, a signal DPP′ is generated in which a signal denoted by (kSPP+MPP) is AC-coupled. Here, AC coupling means removing the direct current component of the signal. Incidentally, the “signal DPP′” is one example of the “noise component” of the present invention. Moreover, the signal shown in FIG. 3(d) is one example of the signal DPP′.

The addition circuit 203 and the capacitor 204 constitute the noise component arithmetic device 21. Incidentally, the capacitor 204 only needs to be an element for removing the direct current component, and it may be, for example, a high-pass filter.

The subtraction circuit 205 constitutes the noise removing device 22.

The subtraction circuit 205 subtracts the signal DPP′ from the signal kSPP. By this, a signal SPPII is generated which is denoted by (kSPP−DPP′). As a result, the noise component can be removed from the signal kSPP because the noise component accompanied by the signal kSPP and the signal DPP′ are in phase. In other words, it is possible to remove the noise component caused by the interference between the invalid lights from the optical disc 14 and the reflected lights of the sub beams.

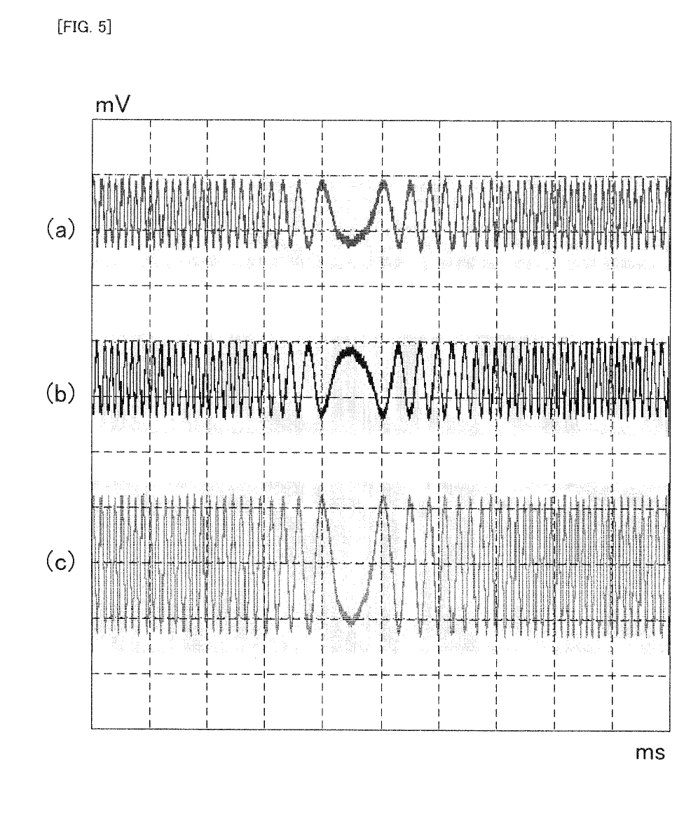

The subtraction circuit 206 subtracts the signal SPPII from the signal MPP. By this, a signal DPPII is generated which is denoted by (MPP−SPPII). Here, an explanation is further added with reference to FIG. 5. FIG. 5 are views showing signals accompanied by the signal processing in the tracking error signal generating device 20 in the first embodiment. FIG. 5(a) to FIG. 5(c) are another example of the signal MPP, one example of the signal SPPII, and one example of the signal DPPII, respectively. As seen from FIG. 5(b), the signal SPPII does not have winding or a swell because the noise component is removed by the noise removing device 22. Thus, by subtracting the signal SPPII from the signal MPP, it is possible to obtain the signal DPPII without the noise component caused by the interference between the invalid lights from the optical disc 14 and the reflected lights of the sub beams.

By the way, since the signal SPPII is the signal in which the noise component is removed from the signal kSPP, the signal DPPII is the same as the signal in which the noise component is removed from the tracking error signal by the DPP method and which is denoted by (MPP−k×SPP)=(MPP−kSPP). Thus, by using the signal DPPII as the tracking error signal TE, it is possible to obtain the low-noise tracking error signal.

As explained above, according to the first embodiment, it is possible to obtain the tracking error signal TE in which the noise component is removed, wherein the noise component is generated in the signal SPP due to the interference between the invalid lights from the optical disc 14 and the reflected lights of the sub beams. Therefore, it is possible to obtain the low-noise tracking error signal in recording or reproducing the information by irradiating the optical disc formed with the plurality of recording layers laminated, with the beam.

### Second Embodiment

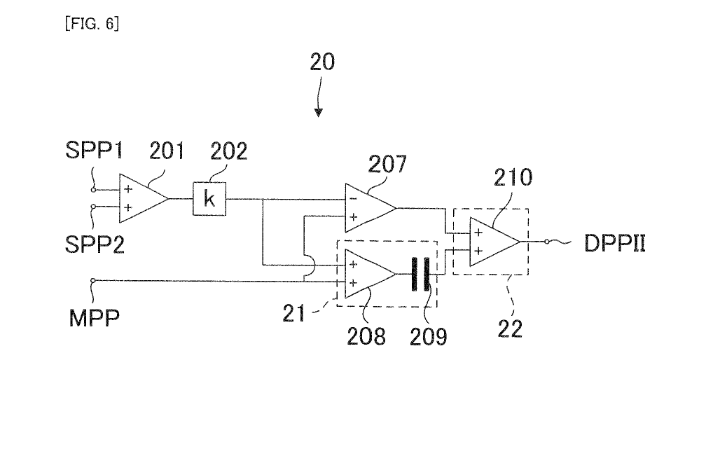

A second embodiment of the noise removing apparatus and method, and the optical pickup of the present invention will be explained with reference to FIG. 6. In the second embodiment, the process of signal processing in the tracking error signal generating device is different from that in the first embodiment. Thus, in the second embodiment, the repetitive explanation of the first embodiment will be omitted. The common points on the drawing carry the same reference numerals, and only different points will be explained with reference to FIG. 6.

Firstly, with reference to FIG. 6, the structure of a tracking error signal generating device 20 in the second embodiment will be explained. FIG. 6 is a block diagram showing the tracking error signal generating device 20 in the second embodiment.

In FIG. 6, the tracking error signal generating device 20 is provided with addition circuits 201, 208, and 210, a subtraction circuit 207, an amplification circuit 202, and a capacitor 209.

Next, an explanation will be given on the method of calculating the noise component generated in the signal SPP and removing the noise component from the tracking error signal TE, in the tracking error generating device 20.

The addition circuit 201 adds the signal SPP1 and the signal. SPP2 to generate the signal SPP. The amplification circuit 202 amplifies the signal SPP using the predetermined gain k to generate the signal kSPP. Here, the predetermined gain k is an arbitrary coefficient expressed by a ratio of the amplitude of the signal MPP and the amplitude of the signal SPP. Incidentally, the “signal kSPP” in the embodiment is one example of the “first arithmetic signal” of the present invention.

The subtraction circuit 207 subtracts the signal kSPP from the signal MPP. By this, the signal DPP is generated which is denoted by (MPP−kSPP). Incidentally, the “signal DPP” in the embodiment is one example of the “second arithmetic signal” of the present invention.

The addition circuit 208 adds the signal kSPP and the signal MPP. The capacitor 209 removes the direct current component from the signal added by the addition circuit 208. By this, the signal DPP′ is generated in which a signal denoted by (kSPP+MPP) is AC-coupled. Incidentally, the “signal DPP′” in the embodiment is one example of the “noise component” of the present invention.

The addition circuit 208 and the capacitor 209 constitute the noise component arithmetic device 21. Incidentally, the capacitor 209 only needs to be an element for removing the direct current component, and it may be, for example, a high-pass filter.

The addition circuit 210 constitutes the noise removing device 22. The addition circuit 210 adds the signal DPP and the signal DPP′. By this, the signal DPPII is generated which is denoted by (DPP+DPP′). As a result, the noise component can be removed from the signal DPP because the noise component accompanied by the signal DPP and the signal DPP′ are in antiphase. Thus, by using the signal DPPII as the tracking error signal TE, it is possible to obtain the low-noise tracking error signal.

As described above, according to the second embodiment, it is possible to obtain the tracking error signal TE in which the noise component is removed, wherein the noise component is generated in the signal SPP due to the interference between the invalid lights from the optical disc 14 and the reflected lights of the sub beams. Therefore, it is possible to obtain the low-noise tracking error signal in recording or reproducing the information by irradiating the optical disc formed with the plurality of recording layers laminated, with the beam.

Incidentally, the present invention is not limited to the aforementioned embodiments, but various changes may be made, if desired, without departing from the essence or spirit of the invention which can be read from the claims and the entire specification. A noise removing apparatus and method and an optical pickup, all of which involve such changes, are also intended to be within the technical scope of the present invention.

1. A noise removing apparatus in an optical pickup comprising: an irradiating device for irradiating a main beam and sub beams toward an optical disc in which at least first and second recording layers are laminated; a focusing device for selectively focusing the emitted main beam and sub beams, on one of the first and second recording layers; a main light receiving element for receiving main light from the optical disc caused by the focused main beam and outputting a main light signal; sub light receiving elements for receiving sub lights from the optical disc caused by the focused sub beams and outputting sub light signals; and a tracking error signal generating device for generating a tracking error signal on the basis of the sub light signals, said noise removing apparatus comprising:
a noise component arithmetic device for calculating, on the basis of the main light signal and the sub light signals, a noise component generated in the sub light signals due to an interference between the sub lights and invalid lights, the invalid lights being caused by at least one of the main beam and the sub beams, the invalid lights come from the other of the first and second recording layers, and the invalid lights are received with the sub lights by said sub light receiving elements; and
a noise removing device for removing the calculated noise component from the tracking error signal.

2. The noise removing apparatus according to claim 1, wherein said noise component arithmetic device adds a first arithmetic signal, which is obtained by multiplying the sub light signals by a constant, and the main light signal, and removes a direct current component of the added signal, to thereby calculate the noise component.

3. The noise removing apparatus according to claim 2, wherein said noise removing device removes the noise component from the tracking error signal by removing the noise component from the first arithmetic signal.

4. The noise removing apparatus according to claim 2, wherein said noise removing device removes the noise component from the tracking error signal by removing the noise component from a second arithmetic signal, which is obtained by subtracting the first arithmetic signal from the main light signal.

5. A noise removing method, in an optical pickup comprising: an irradiating device for irradiating a main beam and sub beams toward an optical disc in which at least first and second recording layers are laminated; a focusing device for selectively focusing the emitted main beam and sub beams, on one of the first and second recording layers; a main light receiving element for receiving main light from the optical disc caused by the focused main beam and outputting a main light signal; sub light receiving elements for receiving sub lights from the optical disc caused by the focused sub beams and outputting sub light signals; and a tracking error signal generating device for generating a tracking error signal on the basis of the sub light signals, said noise removing method removing a noise component generated in the sub light signals due to an interference between the sub lights and invalid lights, the invalid lights being caused by at least one of the main beam and the sub beams, the invalid lights come from the other of the first and second recording layers, and the invalid lights are received with the sub lights by said sub light receiving elements, said noise removing method comprising:
a noise component arithmetic process of calculating the noise component, on the basis of the main light signal and the sub light signals; and
a noise removing process of removing the calculated noise component from the tracking error signal.

6. An optical pickup comprising:
an irradiating device for irradiating a main beam and sub beams toward an optical disc in which at least first and second recording layers are laminated;
a focusing device for selectively focusing the emitted main beam and sub beams, on one of the first and second recording layers;
a main light receiving element for receiving main light from the optical disc caused by the focused main beam and outputting a main light signal;
sub light receiving elements for receiving sub lights from the optical disc caused by the focused sub beams and outputting sub light signals;
a tracking error signal generating device for generating a tracking error signal on the basis of the sub light signals;
a noise component arithmetic device for calculating, on the basis of the main light signal and the sub light signals, a noise component generated in the sub light signals due to an interference between the sub lights and invalid lights, the invalid lights being caused by at least one of the main beam and the sub beams, the invalid lights come from the other of the first and second recording layers, and the invalid lights are received with the sub lights by said sub light receiving elements; and
a noise removing device for removing the calculated noise component from the tracking error signal.
